(19) United States
(12) Patent Application Publication
(10) Pub. No.: US 2005/0149371 A1
(43) Pub. Date: Jul. 7, 2005

(54) ELECTRONIC FORM SYSTEM AND METHOD THEREOF

(76) Inventors: Jenny Wang, Taipei Hsien (TW); Kent Lin, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/711,165

(22) Filed: Aug. 29, 2004

(30) Foreign Application Priority Data
Jan. 5, 2004 (TW) 093100167

(51) Int. Cl. G06F 17/60

(52) U.S. Cl. 705/8

(57) ABSTRACT

An electronic form system and a method thereof. The method includes receiving a first business electronic form submitted by a user, reading a second business electronic form previously submitted by the user, and determining whether a first business time recorded by the first business electronic form is continuous and a second business time recorded by the second business electronic form and the first business time are at least partially overlapped. The first business electronic form is not stored if the first business time is not continuous and the second business time and the first business time are at least partially overlapped.

### BACKGROUND OF INVENTION

1. Field of the Invention

The present invention relates to an electronic management and a method thereof. More specifically, the present invention discloses an electronic form system and a method thereof.

2. Description of the Prior Art

Regarding general enterprises and companies, an employee has to apply a business trip application form for a business trip. Therefore, the employee needs to do the paperwork for filling in the business trip application form to state a period of the business trip, a destination of the business trip, and a reason of the business trip, and etc. Then, the business trip application form is delivered to a corresponding supervisor in charge of examining the applied business trip application form. When the supervisor has approved the business trip application form, the employer is permitted to handle the business according to the period and the destination of the business trip booked on the business trip application form.

After the employer finishes handling the business, the employer will submit a reimbursement application form according to the expense of the business trip. Similarly, the employer has to pass the reimbursement application form to a corresponding supervisor. After the reimbursement application form is approved by the supervisor, a financial department will work on the appropriation of money according to the allowed reimbursement application form. Because the prior art business trip management utilizes paper sheets to be the required application forms and the application forms are delivered manually, the processing of the application forms, therefore, is not efficient.

In addition, suppose that the employee has completed filling in the business trip application form, and the employee erroneously filled in the wrong business trip period. That is, the wrong period overlaps a period of a previously allowed business trip. Therefore, if the supervisor does not find out the wrong business trip period when examining the business trip application form, and allows this incorrect business trip application form, one date will correspond to two different business trips applied by the same employee. Therefore, the financial department will pay the employee twice when working on the reimbursement of the expense of one “actual” business trip. On the contrary, if the supervisor finds in the incorrect business trip period, the supervisor will reject this erroneous business trip application form, and asks the employee to submit a new business trip application form containing the correct business trip period again. As mentioned above, the business trip application forms are paper sheets, and are delivered manually. Therefore, before the correct business trip application form is passed to the supervisor, a great amount of time is wasted owing to the time-consuming delivery.

### SUMMARY OF THE INVENTION

The present invention provides an electronic form system and a method thereof to solve the above-mentioned problem.

Briefly summarized, one preferred embodiment of the present invention discloses a method of operating an electronic form system comprising receiving a business trip electronic form inputted from a user, determining whether a predetermined business trip period recorded by the business trip electronic form is continuous, and storing the business trip electronic form if the predetermined business trip period is continuous.

Another preferred embodiment of the present invention further discloses a method of operating an electronic form system comprising receiving a first business trip electronic form inputted from a user, reading a second business trip electronic form previously applied by the user, comparing a first business trip period recorded by the first business trip electronic form with a second business trip period recorded by the second business trip electronic form, and storing the first business trip electronic form if the first business trip period does not overlap the second business trip period.

The preferred embodiments of the present invention further disclos an electronic form operating system comprising a receiving module for receiving a business trip electronic form inputted from a user, a first storage module for storing business trip data, and a computing module electrically connected to the receiving module and the first storage module for determining whether a predetermined business trip period recorded by the business trip electronic form is continuous.

The computing module stores the business trip electronic form in the first storage module if the predetermined business trip period is continuous.

The preferred embodiments of the present invention further disclos an electronic form operating system comprising a receiving module for receiving a first business trip electronic form inputted from a user, a first storage module for storing business trip data, and a computing module electrically connected to the receiving module and the first storage module for reading a second business trip electronic form previously applied by the user and comparing a first business trip period recorded by the first business trip electronic form with a second business trip period recorded by the second business trip electronic form. The computing module stores the first business trip electronic form in the first storage module if the first business trip period does not overlap the second business trip period.

It is an advantage of the present invention that the claimed business trip electronic form system immediately checks the business trip period when the applicant fills in the business trip electronic form. When the business trip period filled in the business trip electronic form is illegal, the claimed business trip electronic form system does not store the business trip electronic form, and displays a warming message right away to ask the applicant to fill correct data in the business trip electronic form. Therefore, the efficiency of processing the electronic forms is improved because the electronic forms are free of the prior art time-consuming delivery for paper sheets.

These and other contents of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a flow chart illustrating operations of the business trip electronic form system according to the present invention.

FIG. 2 is a detailed flow chart illustrating operations of processing a business trip electronic form through the business trip electronic form system according to the present invention.

FIG. 3 is a detailed flow chart illustrating the operations of revising a business trip electronic form through the business trip electronic form system according to the present invention.

FIG. 4 is a detailed flow chart illustrating operations of canceling a business trip electronic form through the business trip electronic form system according to the present invention.

FIG. 5 is a detailed flow chart illustrating operations of running a reimbursement procedure through the business trip electronic form system according to the present invention.

FIG. 6 is a block diagram of the business trip electronic form system according to the present invention.

### DETAILED DESCRIPTION

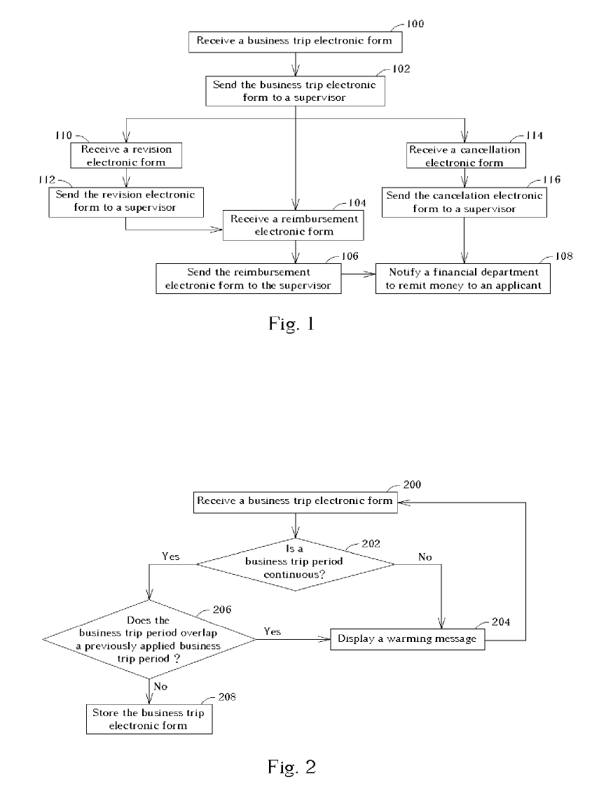

Please refer to FIG. 1, which is a flow chart illustrating operations of the business trip electronic form system according to the present invention. In the beginning, an employee (applicant) fills in a business trip electronic form through a computer device, and then the business trip electronic form system receives the applied business trip electronic form (step 100). The employee fills in the business trip electronic form with data including the business trip period, the destination of the business trip, and the reason of the business trip. Then, the business trip electronic form system according to the present invention sends a message, such as an E-mail, to inform a related supervisor about this applied business trip electronic form (step 102). Therefore, the supervisor is notified, and is capable of examining the applied business trip electronic form when receiving the incoming notification message. After the employee completes handling the business corresponding to the period and the destination of the business trip, the business trip electronic form system is sure to receive a reimbursement electronic form submitted by the employee. Then, the invoices of the expense for the business trip are passed to a financial department for running a following reimbursement procedure (step 104). Similarly, the business trip electronic form system sends a message, such as an E-mail, again to inform the supervisor about the applied reimbursement electronic form (step 106). Then, the notified supervisor examines the applied reimbursement electronic form when receiving the incoming notification. After the reimbursement electronic form is allowed by the supervisor, the business trip electronic form system notifies the financial department so that the financial department is capable of running the reimbursement procedure according to the business trip period recorded by the business trip electronic form and the expense information recorded by the reimbursement electronic form (step 108). For instance, suppose that the business trip period includes T days (filled in the business trip electronic form), the company subsidizes the employee on a business trip by a predetermined amount of money per day M, and the employee, before the business trip or during the business trip, spends an amount of money N (filled in the reimbursement electronic form) for the business trip. Therefore, the financial department will remit a total amount of money M*T+N to the employee.

However, if the employee wants to modify the schedule of the business trip between the time when the supervisor has allowed the business trip electronic form submitted by the employee and the time when the employee begins the predetermined business trip according to the information recorded by the applied business trip electronic form, the employee is capable of activating a revision procedure through the business trip electronic form system according to the present invention for revising the previously applied business trip electronic form. That is, the business trip electronic form system receives data inputted for the revision procedure, and works on the inputted data (step 110). Therefore, the employee is capable of changing the information such as the period and the destination of the business trip originally recorded by the applied business trip electronic form. When the employee has finished revising the original business trip electronic form, the business trip electronic form system similarly sends a message to tell the supervisor to examine this revised business trip electronic form (step 112). In the end, the employee can handle the business according to the modified schedule of the business trip, and fills in the reimbursement electronic form after the business trip is over. In addition, the invoices of the expense for the business trip are submitted to the financial department, and the following reimbursement procedure is started (step 104).

Furthermore, if the employee wants to cancel the schedule of the business trip between the time when the supervisor has allowed the business trip electronic form submitted by the employee and the time when the employee begins the predetermined business trip according to the information recorded by the applied business trip electronic form, the employee is capable of activating a cancellation procedure through the business trip electronic form system according to the present invention for deleting the previously applied business trip electronic form. Therefore, the business trip electronic form system receives data inputted for the cancellation procedure, and processes the inputted data (step 114). Then, the employee is capable of filling in the reimbursement electronic form after the business trip electronic form is successfully deleted. That is, the information of the expense for preparing for the business trip is filled in the reimbursement electronic form. Similarly, the business trip electronic form system sends an E-mail or other message to the supervisor for telling the supervisor to examine the reimbursement electronic form submitted because of the cancellation of the originally determined business trip (step 116). After the reimbursement electronic form is allowed, the business trip electronic form system makes use of the E-mail or other available message to notify the financial department. In the end, the financial department runs a following reimbursement procedure according to the expense information listed on the reimbursement electronic form (step 108).

The preferred embodiment maintains the flow of the electronic forms with the powerful data processing capacity provided by computer devices. Therefore, the data processing efficiency is improved. For example, the related personnel are notified by E-mails to begin following procedures. As mentioned above, the financial department runs the reimbursement procedure according to the business trip period filled in the allowed business trip electronic form and the expense information filled in the allowed reimbursement electronic form. It is clear that the recorded business trip period is sure to affect the proceeding reimbursement procedure. Therefore, when the employee fills out a business trip electronic form, the business trip electronic form system according to the present invention activates a checking procedure to prevent the financial department from paying an erroneous amount of money to the employee. Please refer to FIG. 2, which is a detailed flow chart illustrating operations of processing a business trip electronic form through the business trip electronic form system according to the present invention. The flow includes following steps:
Step 200: Receive a business trip electronic form;
Step 202: Check if a business trip period is a continuous period. If the business trip period is continuous, go to step 206; otherwise, go to step 200;
Step 204: Display a warming message, and return to step 200;
Step 206: Access a business trip database, and check if the business trip period filled in the business trip electronic form overlaps a period of a business trip filled in a previously submitted business trip electronic form. If they overlaps, go to step 204; otherwise, go to step 208; and
Step 208: Store the business trip electronic form into the business trip database.

When an employee utilizes a computer device to fill in a business trip electronic form, the computer device receives the business trip electronic form with business trip information including a period and a destination inputted by an employee (step 200). Then, the business trip electronic form system starts reading the applied business trip electronic form to check if the recorded business trip period is a continuous one (step 202). If the recorded business trip period is not continuous, the business trip electronic form system according to the present invention displays a warming message on a monitor, or by voice etc, of the computer device to notify the employee (step 204), and returns to step 200 for asking the employee to fill in the applied business trip electronic form with a correct business trip period. In the preferred embodiment, the objective of limiting the business trip period to be a continuous period is to help a following reimbursement procedure. The detailed operation is described later.

When the recorded business trip period is continuous, the business trip electronic form system according to the present invention accesses a business trip database for retrieving a business trip electronic form previously submitted by the same employee, and checks if the business trip period filled in the currently applied business trip electronic form overlaps a period of one business trip filled in one previously applied business trip electronic form (step 206). If the business trip period filled in the currently applied business trip electronic form does overlap the period of one business trip filled in the previously applied business trip electronic form, it means that the employee might apply two business trip electronic forms for the same business trip. That is, one date will correspond to two different business trips, which means that the reimbursement procedure will erroneously pay twice for the same date owing to two applied business trip electronic forms. Therefore, the business trip electronic form system will show a warming message to notify the employee that the currently inputted business trip electronic form is illegal (step 204), and asks the employee to fill out a new business trip electronic form again with correct information (step 200). On the contrary, if the business trip period filled in the currently applied business trip electronic form does not overlap the period of one business trip filled in any previously applied business trip electronic forms, the business trip electronic form system according to the present invention stores the business trip electronic form submitted by the employee into the business trip database (step 208). As shown in FIG. 1, after the newly applied business trip electronic form is kept by the business trip database, the business trip electronic form system according to the present invention activates an examination procedure (step 102).

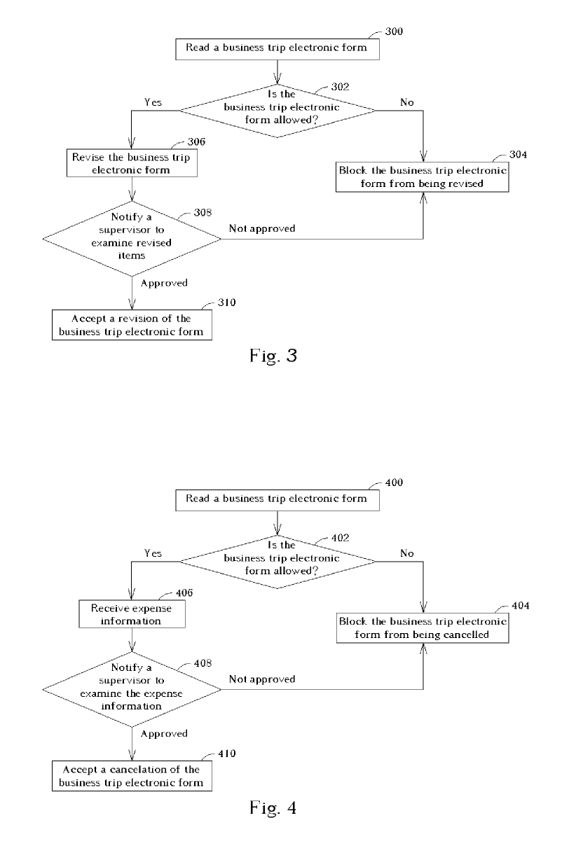

Please refer to FIG. 3, which is a detailed flow chart illustrating the operations of revising a business trip electronic form through the business trip electronic form system according to the present invention. The flow includes following steps:
Step 300: Read a business trip electronic form submitted by an employee;
Step 302: Is the business trip electronic form allowed? If yes, go to step 306; otherwise, go to step 304;
Step 304: Block the business trip electronic form from being revised;
Step 306: Revise the business trip electronic form;
Step 308: A supervisor examines these revised items. If the supervisor allows these revised items, go to step 310; otherwise, go to step 304; and
Step 310: Accept these revised items for the business trip electronic form.

The flow chart shown in FIG. 3 corresponds to steps 110 and 112 shown in FIG. 1. As mentioned before, the employee is capable of modifying the recorded schedule of the business trip through the business trip electronic form system according to the present invention before the employee begins the business trip according to the information filled in the corresponding business trip electronic form. Therefore, the business trip electronic form system retrieves a business trip electronic form previously submitted by the employee (step 300). Next, the business trip electronic form system checks the business trip electronic form to see if it has been allowed through step 102 shown in FIG. 1. If the business trip electronic form is not allowed by the supervisor yet, the business trip electronic form system does not allow the employee to revise the business trip electronic form (step 304). On the contrary, when the business trip electronic form is already allowed by the supervisor, the employee is allowed to revise the information such as the period and the destination of the business trip filled in the original business trip electronic form (step 306). Similarly, these revised items of the business trip electronic form should be further examined by the supervisor (step 308). If the supervisor does not approve these revised items, the business trip electronic form system according to the present invention will block the original business trip electronic form from being modified by the employee. However, if the supervisor allows these revised items for the original business trip electronic form, the business trip electronic form system will accept these revised items to update the original business trip electronic form (step 310).

Please refer to FIG. 4, which is a detailed flow chart illustrating operations of canceling a business trip electronic form through the business trip electronic form system according to the present invention. The flow includes following steps:
Step 400: Read a business trip electronic form applied by an employee;
Step 402: Is the business trip electronic form allowed? If yes, go to step 406; otherwise, go to step 404;
Step 404: Block the business trip electronic form from being cancelled;
Step 406: The employee fills in detailed information of the expense;
Step 408: A supervisor examines the expense information filled in by the employee. If the supervisor approves the expense information, go to step 410; otherwise, go to step 404; and
Step 410: Accept the cancellation of the business trip electronic form.
The flow shown in FIG. 4 corresponds to step s 114 and 116 shown in FIG. 1. As mentioned before, the employee is capable of canceling the recorded schedule of the business trip through the business trip electronic form system according to the present invention before the employee begins the business trip according to the information filled in the corresponding business trip electronic form. Therefore, the business trip electronic form system retrieves a business trip electronic form previously submitted by the employee (step 400). Next, the business trip electronic form system checks the business trip electronic form to see if it has been allowed through step 102 shown in FIG. 1. If the business trip electronic form is not allowed by the supervisor yet, the business trip electronic form system does not allow the employee to cancel the business trip electronic form (step 404). On the contrary, if the business trip electronic form is already allowed by the supervisor, the employee is allowed to start providing information of the expense for preparing for the business trip (step 406). Similarly, the listed expense information should be further examined by the supervisor (step 408). If the supervisor does not approve the listed expense information, the business trip electronic form system according to the present invention will block the original business trip electronic form from being cancelled by the employee. However, if the supervisor allows the listed expense information, the business trip electronic form system will accept the cancellation of the business trip electronic form (step 410). Through step 108 shown in FIG. 1, a reimbursement procedure is started to remit money to the employee according to the listed expense information.

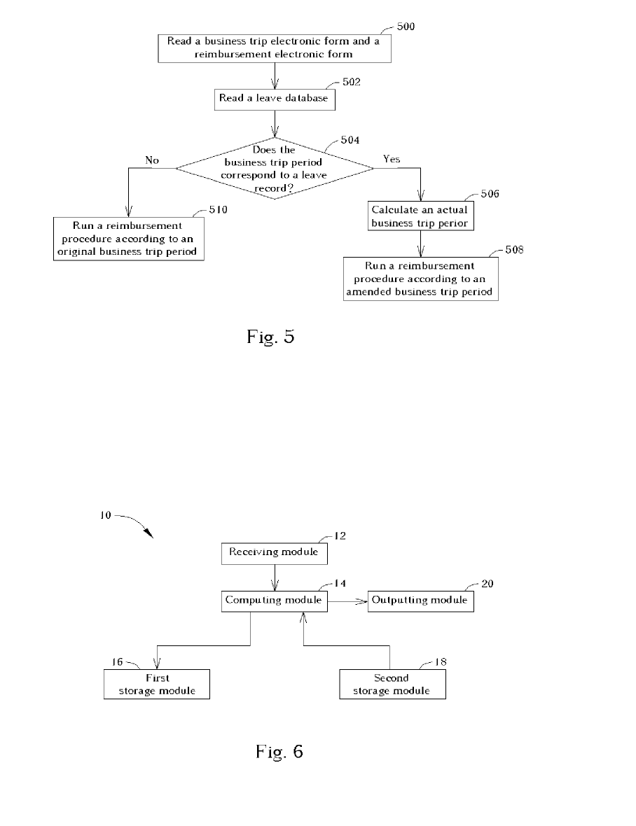

In the preferred embodiment, the step 202 shown in FIG. 2 is used to integrate the business trip electronic form system with a leave management system for helping the execution of the reimbursement procedure. Please refer to FIG. 5, which is a detailed flow chart illustrating operations of running a reimbursement procedure through the business trip electronic form system according to the present invention. The flow includes following steps:
Step 500: Read a business trip electronic form and a reimbursement electronic form applied by an employee;
Step 502: Read a database of leave records to retrieve a leave record of the employee;
Step 504: Is one date within a business trip period recorded by the business trip electronic form listed in the leave record? If yes, go to step 506; otherwise, go to step 510;
Step 506: Calculate an actual business trip period according to the leave record;
Step 508: Run the reimbursement procedure according to an amended business trip period; and
Step 510: Run the reimbursement procedure according to an original business trip period.

As shown in FIG. 1, the employee fills the expense information in a reimbursement electronic form (step 104). After the supervisor approves the reimbursement electronic form (step 106), the financial department will run the reimbursement procedure according to the allowed business trip electronic form and the allowed reimbursement electronic form (step 108). Therefore, when the reimbursement procedure is started, the business trip electronic form system according to the present invention reads the allowed business trip electronic form and the allowed reimbursement electronic form in the beginning (step 500). Generally speaking, the leave record has information including a period of a leave and a corresponding leave category the leave belongs to. Suppose that the business trip period includes two separate periods A-B and C-D. That is, a period B-C is excluded from the business trip period. As mentioned before, the employee is forced to fill in a continuous period for the business trip. Therefore, the business trip period filled in the business trip electronic form will be a period A-D. Though the recorded business trip period includes the period B-C, the employee has to submit a leave application for this period B-C. Therefore, the leave record of the employee will record this period B-C. Suppose that each of the periods A-B, B-C, and C-D includes 3 days. Therefore, the business trip period filled in the business trip electronic form accordingly includes 9 days because of the added period B-C. However, the leave record of the employee tells that the recorded period (the period A-D) of the business trip contains a leave period (the period B-C) of 3 days. The business trip electronic form system, therefore, is capable of calculating an actual business trip period. That is, the actual period is established by the periods A-B and C-D, and includes 6 days instead of 9 days.

Suppose that the company subsidizes the employee on a business trip by a predetermined amount of money per day M, and the employee, before the business trip or during the business trip, spends an amount of money N for the business trip. Therefore, the financial department will remit a total amount of money M*6+N to the employee according to the amended business trip period and the reimbursement electronic form (step 508). To sum up, the business trip electronic form system according to the present invention prevents the financial department from erroneously remitting money to the employee according to the leave period.

In addition, if step 504 finds in that these dates within the business trip period are not recorded in the leave record, that is, the actual business trip period is equal to the originally recorded business trip period, the financial department will run the reimbursement procedure according to the original business trip period filled in the business trip electronic form and the expense information listed in the reimbursement electronic form (step 510).

Please note that step 202 in the preferred embodiment is performed before step 206. However, step 206 also can be performed before step 202 within the flow shown in FIG. 2. That is, determine if a period of a business trip filled in a current business trip electronic form overlaps a period of a business trip filled in a previously applied business trip electronic form, and then check if the business trip period filled in this current business trip electronic form is a continuous period. In addition, the preferred embodiment utilizes steps 202 and 206 to check the validity of the business trip period filled in by the employee. However, the preferred embodiment also can utilize one of steps 202 and 206 to check the validity of the business trip period filled in by the employee. The same objective of immediately checking the validity of the business trip period is achieved.

Please refer to FIG. 6, which is a block diagram of the business trip electronic form system 10 according to the present invention. The business trip electronic form system 10 comprises a receiving module 12, a computing module 14, a first storage module 16, a second storage module 18, and an outputting module 20. The receiving module 12 is used for receiving data and commands inputted by a user. For instance, receiving module 12 receives data corresponding to the business trip electronic form, data filled in for revising the business trip electronic form, and expense information filled in for the reimbursement procedure. The computing module 14 controls operation of the business trip electronic form system 10 according to the data and commands received by the receiving module 12. For example, the computing module 14 performs step 202 and 204 to check the validity of the business trip electronic form received by the receiving module 12, and performs steps 302 and 402 shown in FIGS. 3-4 to control the revision and cancellation of the business trip electronic form. When the computing module 14 judges that the business trip electronic form received by the receiving module 12 is valid through performing steps 202 and 203, the computing module 14 stores the business trip electronic form into the first storage module 16. For example, the business trip electronic form is kept in a database. In addition, a second storage module 18 is used for storing a database of leave records. Therefore, when the computing module 14 performs step 502 shown in FIG. 5, the computing module 14 accesses the second storage module 18 to retrieve wanted information for calculating the actual business trip period through performing step 506 shown in FIG. 5. In this preferred embodiment, the business trip electronic form system 10 includes the outputting module 20 (ex. a monitor of a client terminal). Therefore, if the computing module 14 has to perform step 204 after performing steps 202 and 206, the computing module 14 drives the outputting module 20 to show a warming message.

In contrast to the prior art, the claimed business trip electronic form system checks the inputted business trip period at the time when the applicant fills out the business trip electronic form, and ensures that the inputted business trip period is continuous. Therefore, when the applicant activates a reimbursement procedure after the business trip, the claimed business trip electronic form system can utilize a database of leave records to calculate an actual business trip period for preventing a financial department from erroneously remitting money to the applicant. In addition, when the applicant fills out a business trip electronic form, the claimed business trip electronic form system retrieves at least a business trip electronic form previously submitted by the same applicant, and checks if a period of a business trip filled in this current business trip electronic form overlaps a period of a business trip filled in previously submitted business trip electronic form for preventing the financial department from erroneously remitting money to the applicant.

Concerning the prior art processing of an application form for a business trip, if the applicant submits an application form filled in a wrong period of a business trip, the illegal application form is rejected by a supervisor, and is returned to the applicant. Then, the applicant has to submit another application form filled in a correct period of a business trip. Therefore, the delivery of paper sheets is time-consuming, and greatly worsens the efficiency of processing the application forms of the business trips. The claimed business trip electronic form system immediately checks the business trip period when the applicant fills out the business trip electronic form. When the business trip period filled in the business trip electronic form is illegal, the claimed business trip electronic form system does not store the business trip electronic form, and displays a warming message right away to ask the applicant to fill correct data in the business trip electronic form. It is clear that the efficiency of processing the electronic forms is improved because the electronic forms are free of the prior art time-consuming delivery for paper sheets. To sum up, the claimed business trip electronic form system not only helps the financial department to handle the reimbursement procedure, but also improves efficiency of processing the application forms for business trips.

Those skilled in the art will readily observe that numerous revisions and alterations of the device may be made while retaining the teachings of the invention. Accordingly, the above disclosure should be construed as limited only by the metes and bounds of the appended claims.

1. A method of operating an electronic form system comprising:
(a) receiving a business trip electronic form inputted from a user; and
(b) determining whether a predetermined business trip period recorded by the business trip electronic form is continuous, and storing the business trip electronic form if the predetermined business trip period is continuous.

2. The method of claim 1 wherein step (b) further comprises:
after storing the business trip electronic form, reading a leave record of the user to determine an actual business trip period according to the leave record and the predetermined business trip period.

3. The method of claim 2 wherein step (b) further comprises:
if the leave record corresponds to a leave period, and the leave period is included in the predetermined business trip period, subtracting the leave period from the predetermined business trip period to determine the actual business trip period.

4. The method of claim 2 wherein step (b) further comprises:
if the leave record does not correspond to the predetermined business trip period, utilizing the predetermined business trip period to be the actual business trip period.

5. The method of claim 1 further comprising:
(c) before the predetermined business trip period, receiving a command inputted from the user for modifying the business trip electronic form.

6. The method of claim 5 wherein step (c) further comprises:
determining whether the business trip electronic form is allowed, revising the business trip electronic form if the business trip electronic form is allowed, and blocking the business trip electronic form from being revised if the business trip electronic form is not allowed yet.

7. The method of claim 1 further comprising:
(c) before the predetermined business trip period, receiving a command inputted from the user for canceling the business trip electronic form.

8. The method of claim 7 wherein step (c) further comprises:
determining whether the business trip electronic form is allowed, canceling the business trip electronic form if the business trip electronic form is allowed, and blocking the business trip electronic form from being cancelled if the business trip electronic form is not allowed yet.

9. The method of claim 1 wherein step (b) further comprises:
if the predetermined business trip period is not continuous, showing a warning message to notify the user.

10. A method of operating an electronic form system comprising:
(a) receiving a first business trip electronic form inputted from a user;
(b) reading a second business trip electronic form previously applied by the user; and
(c) comparing a first business trip period recorded by the first business trip electronic form with a second business trip period recorded by the second business trip electronic form, and storing the first business trip electronic form if the first business trip period does not overlap the second business trip period.

11. The method of claim 11 further comprising:
(d) before the predetermined business trip period, receiving a command inputted from the user for modifying the business trip electronic form, determining if the business trip electronic form is allowed, revising the business trip electronic form if the business trip electronic form is allowed, and blocking the business trip electronic form from being revised if the business trip electronic form is not allowed yet.

12. The method of claim 10 further comprising:
(d) before the predetermined business trip period, receiving a command inputted from the user for canceling the business trip electronic form.

13. The method of claim 12 wherein step (d) further comprises:
determining whether the business trip electronic form is allowed, canceling the business trip electronic form if the business trip electronic form is allowed, and blocking the business trip electronic form from being cancelled if the business trip electronic form is not allowed yet.

14. The method of claim 10 wherein step (c) further comprises:
if the predetermined business trip period is not continuous, showing a warning message to notify the user.

15. An electronic form operating system comprising:
a receiving module for receiving a business trip electronic form inputted from a user;
a first storage module for storing business trip data; and
a computing module electrically connected to the receiving module and the first storage module for determining whether a predetermined business trip period recorded by the business trip electronic form is continuous;
wherein the computing module stores the business trip electronic form in the first storage module if the predetermined business trip period is continuous.

16. The electronic form operating system of claim 15 further comprising a second storage module electrically connected to the computing module for storing leave data, wherein the computing module is further used for reading a leave record of the user to determine an actual business trip period according to the leave record and the predetermined business trip period.

17. The electronic form operating system of claim 15 further comprising an outputting module electrically connected to the computing module, wherein the outputting module shows a warning message to notify the user if the predetermined business trip period is not continuous.

18. An electronic form operating system comprising:
a receiving module for receiving a first business trip electronic form inputted from a user;
a first storage module for storing business trip data; and
a computing module electrically connected to the receiving module and the first storage module for reading a second business trip electronic form previously applied by the user and comparing a first business trip period recorded by the first business trip electronic form with a second business trip period recorded by the second business trip electronic form;
wherein the computing module stores the first business trip electronic form in the first storage module if the first business trip period does not overlap the second business trip period.

19. The electronic form operating system of claim 18 further comprising a second storage module electrically connected to the computing module for storing leave data, wherein the computing module is further used for reading a leave record of the user to determine an actual business trip period according to the leave record and the predetermined business trip period.

20. The electronic form operating system of claim 18 further comprising an outputting module electrically connected to the computing module, wherein the outputting module shows a warning message to notify the user if the predetermined business trip period is not continuous.
